(19) United States
(12) Patent Application Publication
(10) Pub. No.: US 2023/0237669 A1
(43) Pub. Date: Jul. 27, 2023

(54) METHOD AND DEVICE FOR DETERMINING A SIGNAL STATE OF A LIGHT SIGNAL SYSTEM

(71) Applicant: Robert Bosch GmbH, Stuttgart (DE)

(72) Inventors: Jose Domingo Esparza Garcia, Stuttgart (DE); Max Neuner, Boeblingen (DE); Patrick Koegel, Ludwigsburg (DE); Peter Golya, Budapest (HU)

(21) Appl. No.: 18/156,862

(22) Filed: Jan. 19, 2023

(30) Foreign Application Priority Data
Jan. 24, 2022 (DE) 10 2022 200 746.8

(51) Int. Cl. G06T 7/136; G06T 7/174

(52) U.S. Cl. CPC G06T 7/136; G06T 7/174; G06T 2207/30252

(57) ABSTRACT

A method for determining a signal state of a light signal system having several light signal emitters, wherein the light signal system comprises several signal states and a signal state is formed by means of one or more activated light signal emitters. The method includes: determining an object, which represents a signal state of a light signal system; saving a determined first object having a first identifier, if it is detected in a first video image that the first object represents a signal state of the light signal system; changing the identifier of the saved first object from the first identifier to a second identifier, if in a second video image the first object is no longer detected; deleting the saved first object having the second identifier, if a second object is determined in a further video image, which represents a different signal state of the light signal system.

### CROSS REFERENCE

The present application claims the benefit under 35 U.S.C. § 119 of German Patent Application No. DE 10 2022 200 746.8 filed on Jan. 24, 2022, which is expressly incorporated herein by reference in its entirety.

### BRIEF SUMMARY

The present invention relates to a method for determining a signal state of a light signal system having several light signal emitters, wherein the light signal system comprises several signal states, and a signal state is formed by means of one or more activated light signal emitters. According to an example embodiment of the present invention, the method includes the following method steps: determining an object, which represents a signal state of a light signal system; saving a determined first object having a first identifier, if in a first video image, it is detected that the first object represents a signal state of the light signal system; changing the identifier of the saved first object from the first identifier to a second identifier, if in a second video image, the first object is no longer detected; deleting the saved first object having the second identifier, if in a further video image, a second object is determined, which represents a different signal state of the light signal system. Further, the present invention relates to a device configured to execute the method.

### BACKGROUND INFORMATION

In the related art, the driving assistance function “traffic light function” is described. This assistance function comprises a detection of the light signal system, in particular a traffic light, as well as the current signal state of the light signal system. Depending on the detected signal state, the assistance function may provide defined driver support. These comprise, for example, (A) displaying the detected signal state of the traffic light, (B) warning in the case of an impending crossing of a red phase, (C) initiating a braking maneuver up to (D) preparing or assisting with a start-up process.

For example, German Patent Application No. DE 11 2018 000 768 T5 describes a method for detecting false-positive events with respect to a traffic light based on a video stream of images taken by a camera on board a motor vehicle, wherein the traffic light is so configured that it switches between a plurality of states, wherein each state is characterized by at least one colored zone representing a signal. The method comprises a step for filtering the images using a predetermined list of filter criteria with respect to the states of the traffic light, based on a predetermined history of the color of the pixels of the colored zone representing a light object captured in the video stream of images in order to detect false-positive events.

German Patent Application No. DE 10 2019 106 844 A1 describes a method for checking the plausibility of a functionality of a camera arrangement having at least two cameras for determining a switching state of a light signal system by a control device, wherein a first switching state of the light signal system is determined based on measurement data of a first camera, a second switching state of the light signal system is determined based on measurement data from at least a second camera, and the first switching state and the second switching state are used for checking the plausibility of a functionality of the camera arrangement. In this case however, the switching states do not have to be detected simultaneously by both cameras for checking plausibility, but can also be detected in a time-delayed manner, for example, because the light signal system is meanwhile moved from the visual range of one camera.

### SUMMARY

Advantageously, the method and device according to the invention allows an improvement of the driving assistance function “traffic light function”. In particular, an increase in the validity in object detection is thereby achieved, in particular by avoiding so-called ghost images (which occur if several states of an object are incorrectly determined in the image analysis) and the resulting uncertainty as to which state is actually correct. This is made possible by the features of the present invention disclosed herein. Further configurations of the present invention are disclosed herein.

The method according to an example embodiment of the present invention for determining a signal state of a light signal system having several light signal emitters, wherein the light signal system comprises several signal states and a signal state is formed by means of one or more activated light signal emitters, includes the following method steps: determining an object, which represents a signal state of a light signal system; saving a determined first object having a first identifier, if in a first analysis cycle it is detected that the first object represents a signal state of the light signal system; changing the identifier of the saved first object from the first identifier to a second identifier, if the first object is no longer detected in a subsequent analysis cycle; deleting the saved first object having the second identifier, if a second object is determined in an analysis cycle, which represents a different signal state of the light signal system.

This is understood in the sense that video data of a surrounding area of a motor vehicle is analyzed in order to detect light signal systems, in particular traffic lights. Further, not only the light signal system itself, as well as, for example, its position, is to be determined, but also the current signal state. The signal states are formed by encoded activated signal emitters, in particular colored lights. For example, an activated green light indicates the signal state “traffic is allowed”, an activated yellow light “wait for the next signal in front of the intersection”, an activated red light: “stop in front of the intersection” and an activated red and yellow light the signal state “prepare for onward driving.” In order to determine these signal states, an attempt is made in particular to identify the corresponding objects. An object can be, for example, an activated green light of the light signal system. Alternatively, an object may also comprise the entire traffic light display, i.e., an activated green light as well as two non-activated lights above the green light. Using the example of the signal state “prepare for onward driving”, it becomes clear that an object may also comprise several activated signal emitters, if necessary.

Of course, other signal states are also encodable, and other objects possible for this purpose. For example, a light signal system having only two light signal emitters is possible. Further, it is also alternatively or additionally possible that the signal emitter comprises a time table, which, for example, in the form of a countdown, comprises the remaining time until the next phase change.

According to an example embodiment of the present invention, the method provides that in the image data of the area surrounding the motor vehicle, objects are searched for, which represent a (coded) signal state of the light signal system. For this purpose, one or more video images are evaluated in an analysis cycle. If a first signal state of the light signal system is determined based on a first object, which is detected in a first analysis cycle, the object determined in the image data is saved in a memory of the motor vehicle. Further, together with the object, information is saved, which defines that the object was actually determined in the most recently analyzed video images. This is referred to as the first identifier. That is to say, the determined first virtual object, for example the green light of the traffic light, is provided with the label “measured”, which defines the object as “measured” or “detected” and is stored in a memory of the assistance system.

According to an example embodiment of the present invention, the method further provides for further searching for objects which represent a (encoded) signal state of the light signal system also in the subsequent image data of the surrounding area (i.e., in the context of a second analysis cycle). In particular, it is checked whether the previously determined object still exists or can be detected. A non-detection may occur, for example, if the object no longer exists, for example, the green light is no longer active. However, non-detection may also be due to the object being briefly obscured by a surrounding area object.

If the previously determined object is no longer identified in a subsequent—for example, second—analysis cycle, the object saved in the memory is not deleted immediately, but is initially saved further. However, together with the object, information is saved, which defines that the object was no longer determined in the image data in the most recently performed—e.g., second —analysis cycle. This is referred to as the second identifier. That is to say, for example, that the previously saved virtual first object, the green light of the traffic light, remains in the memory of the motor vehicle. However, its label “measured” is removed or replaced by a label “estimated” which defines the object as “estimated”.

The objects saved in the memory—i.e., both an object having a first identifier as “measured” or an object having a second identifier as “estimated” are advantageously considered in the further data evaluation and used, for example, for activation, control of the driving assistance function.

In the further course, however, in a later video image—for example, the third analysis cycle —a second, i.e., a signal state of the light signal system different from the first signal state can also be determined on the basis of a second object. Therefore, a second signal state of the light signal system subsequent to the first signal state is advantageously (also) expected.

If, in this later—for example, third—analysis cycle, the first object is once more not detected again, or is only saved in the memory as a virtual first object having a second identifier, it is assumed that the first object located in the memory is no longer relevant or is no longer correct—for example, because the first object is no longer present in the actual surrounding area. Accordingly, the first object having the second identifier saved in the memory is deleted. In other words, this means that the deletion of the first object defined as estimated occurs if in a further video image, a second object is detected, which corresponds to defined criteria, in particular represents a different signal state of the light system.

In an alternative further development of the present invention, the method includes the method step: deleting the first object having the second identifier if the characteristic of the second object of a defined condition is sufficient, in particular if the signal state of the light signal system represented by the second object is a defined subsequent signal state regarding the signal state of the light signal system represented by the first object.

This is understood in the sense that a property of the determined second object is used as a criterion which is advantageously considered regarding a deletion of the first object. In this case, it can be a property of the second object, which can be independently assessed or which can be assessed depending on the first object, for example. A deletion occurs, for example, if the signal state represented by the determined second object logically correctly follows upon the signal state represented by the determined first object. For example, this is the case with a traffic light having three lights, for example, if a yellow light is detected subsequently to a green light.

Of course, the method may also advantageously comprise one of the further method steps: recording video data as a basis for determining the object representing a signal state of the light signal system.

In a possible configuration of the present invention, the method is characterized by the method step: deleting the first object having the second identifier if the age of the second object is less than a defined threshold value, particularly if the age of the second object is less than the age of the first object.

This is understood in the sense that the age of the determined second object is used as a criterion which is advantageously considered regarding a deletion of the first object. A deletion occurs, for example, if the second object has a lesser age than the first object, i.e., the determined second object is newer.

In a preferred embodiment of the present invention, the method includes the following method step: deleting the first object having the second identifier if a determined size of the second object is within a defined size frame, in particular if a determined size of the second object corresponds to a determined size of the first object within a defined tolerance threshold.

This is understood in the sense that the size of the determined second object is used as a criterion which is advantageously considered regarding a deletion of the first object. A deletion occurs, for example, if the size of the second object is approximately as large as the size of the determined first object. Thereby, it can be ensured that the second object belongs to the same light signal system with a certain probability.

In a possible configuration of the present invention, the method includes the following method step: defining a first environmental estimation area with respect to the first object having the second identifier, in which the first object is expected in a next analysis cycle.

This is understood in the sense that if a previously determined object is not determinable in a current analysis cycle, a surrounding area is estimated, in which this object is in a next analysis cycle and could be detected there anew. Such an environmental estimation area is called a “predictor”.

In a preferred embodiment of the present invention, the method is characterized by the method step: defining a second environmental estimation area with respect to the first object having the second identifier, in which the second object is expected in a next analysis cycle, in particular, wherein the environmental estimation area is defined, in which the second object is expected, considering the current signal state of the light signal system represented by the first object and depending on a specific signal state subsequent thereto, which is represented by the second object.

This is understood in the sense that if a previously determined object cannot be determined in a current analysis cycle, a surrounding area is estimated, in which a previously not determined second object could be located, which could reappear due to, for example, a change in the state of the light signal system. Advantageously, the surrounding area in which the second object can be expected is determined depending on the signal state of the light signal system represented by the first object. Such an environmental estimation area is called a “predictor”.

This is to be illustrated by the following example. For example, a green light is determined as the first object. The second object corresponds to a changed signal state of the light signal system. After the “green” state, the “yellow” state is expected. The expected second object “yellow light” is located spatially above the previous first object “green light”. Thus, the estimation area in which the second object is expected is defined so as to be located spatially above the area of the previously detected first object.

In one advantageous embodiment of the present invention, the method includes the following method step: deleting the first object having the second identifier if the second object is determined in the defined second environmental estimation area with respect to the first object.

In an advantageous configuration of the present invention, the method includes the following method step: saving the second object having a first identifier if the first object having the second identifier is deleted.

In one possible embodiment of the present invention, the method includes the method step: considering the saved object having the first identifier, or the second identifier in the further data evaluation.

This is understood in the sense that not only the objects, which are identified as being currently detected, but also objects, which are identified as being estimated, are considered in the further course. The aforementioned data evaluation may comprise aspects of the analysis up to the execution of the driving assistance function “traffic light function”.

In an alternative embodiment of the present invention, the method includes the method step: determining an object representing a signal state of a light signal system within a defined environmental estimation area if the first object having the second identifier is saved.

This is understood in the sense that advantageously the respective object is searched for only within the defined environmental estimation area, for example, only the data material, which is limited by the environmental estimation area, is evaluated. Advantageously, computational capacity can be conserved hereby. In an alternative embodiment, by contrast, all of the video data are considered and analyzed, but the criterion of the environmental estimation area is used as a condition in an evaluation of a determined object. Thereby, the certainty of a correct evaluation is increased.

This method can be implemented, for example, in software or hardware or in a mixed form of software and hardware, for example in a controller.

The approach presented here furthermore according to the present invention also provides a device which is designed to carry out, control, or implement the steps of a variant of a method presented here in corresponding devices. The objective of the present invention can also be achieved quickly and efficiently by this embodiment variant of the present invention in the form of a device.

In the present case, a device can be understood to mean an electrical device that processes sensor signals and, as a function thereof, outputs control signals and/or data signals. The device may have an interface that may be configured as hardware and/or software. In a hardware configuration, the interfaces can be part of a so-called system ASIC, for example, which contains various functions of the device. However, it is also possible that the interfaces are separate, integrated circuits or at least partially consist of discrete structural elements. In a software configuration, the interfaces can be software modules that are present, for example, on a microcontroller in addition to other software modules.

The device can therefore be an assistance system for supporting traffic light detection for a motor vehicle, an assistance system for automated control of the longitudinal guidance, a surrounding area detection device, in particular a camera, as well as a central or decentralized controller, which is configured to control one of the aforementioned devices and/or to execute the method.

A computer program product or a computer program having program code that can be saved on a machine-readable carrier or storage medium, such as a semiconductor memory, a hard disk memory, or an optical memory, and that is used for carrying out, implementing, and/or controlling the steps of the method according to one of the embodiments of the present invention described above is advantageous as well, in particular if the program product or program is executed on a computer or a device.

It should be noted that the features individually listed in the description can be combined together in any technically meaningful manner and show further configurations of the invention. Further features and practicality of the present invention arise from the description of embodiment examples based on the figures.

### BRIEF DESCRIPTION OF THE DRAWINGS

FIG. 1 shows a schematic representation of an example configuration of the present invention.

FIG. 2 shows a representation of the method steps of one example embodiment of the present invention.

### DETAILED DESCRIPTION OF EXAMPLE EMBODIMENTS

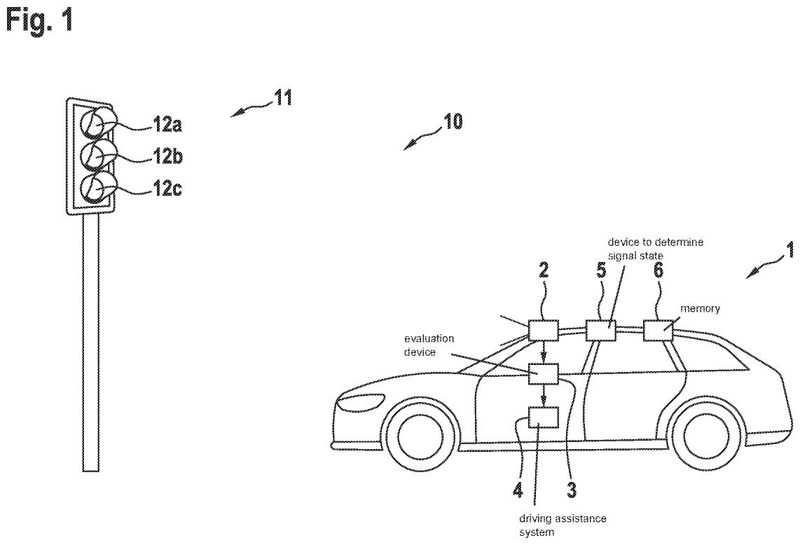

FIG. 1 shows a schematic representation of a first embodiment of the present invention. In this case, a motor vehicle 1 is shown in surrounding area 10. The motor vehicle 1 has a video system 2. By means of the video system 2, image data of the area surrounding the motor vehicle 1 are recorded. This image data are evaluated by an evaluation device 3 by means of an evaluation software. In this case, signals are generated and forwarded to the driving assistance system 4. For example, the driving assistance system 4 may execute automated driving maneuvers, for example, automated braking or automated start-up. Also, if necessary, the driving assistance system 4 may communicate specific information to the driver. Further, a device 5 for determining a signal state of a light signal system having several light signal emitters can be configured as a stand-alone device. However, this device 5 can also be integrated into the evaluation device 3. Of course, integration directly into the video system 2 or into the driving assistance system 4 is also possible. Further, a digital memory 6 located in the motor vehicle 1 is shown. Detected objects are saved in the digital memory for a limited time. Additional information regarding the objects can also be saved herein, for example, whether an object is labelled (i.e. defined or identified) as “recognized” or as “estimated”.

Further, a light signal system 11 (e.g., a light signal system or traffic light) is shown in the surrounding area 10 of the motor vehicle 1. The light signal system 11 comprises three light signal emitters 12a, 12b, 12c. The upper light signal emitter 12a is a red light. The center light signal emitter 12b is a yellow light. The lower light signal emitter 12c is a green light. These light signal emitters 12a, 12b, 12c represent a defined signal state of the light signal system 11 when activated. Mostly four signal states (short: states) are defined. An activated light signal emitter 12c (green light) describes the state “traffic is allowed”. An activated light signal emitter 12b (yellow light) describes the state “wait in front of the intersection for the next signal”. An activated light signal emitter 12a (red light) describes the state “stop in front of the intersection”. Parallelly activated light emitters 12a and 12b (red and yellow lights) describe the state “prepare for onward driving”.

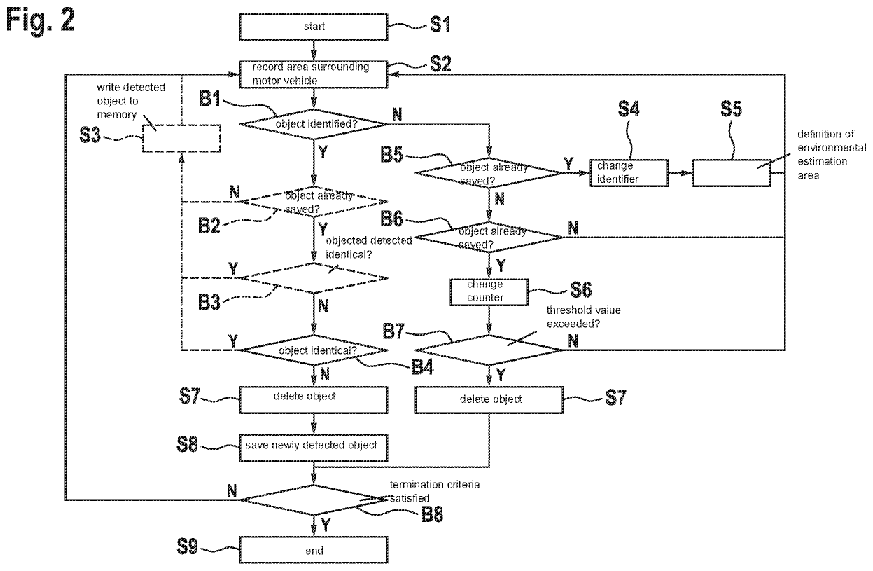

In FIG. 2 a representation of the method steps of an embodiment of the invention is shown. In this case, in a first step S1, the method is started. In a next step S2, the recording of the area surrounding the motor vehicle is carried out by means of a video camera—and thus at the same time the generation of video images as a starting point for the subsequent analysis.

In this case, using condition B1 it is checked whether a relevant object in a video image is identified. A relevant object is in particular an object that represents a signal state of a light signal system. For example, an activated red light of a traffic light detected in the video image may be such an object.

If the condition B1 is satisfied (Y branch), i.e., if a relevant object is determined in the data, a condition B2 or B4 is checked. The conditions B2 and B3 as well as the method step S3 are shown by dashed lines in the figure. This means that these are optional embodiment possibilities. If, on the other hand, the condition B1 is not satisfied (N branch), another condition B5 is checked.

By means of condition B2, it is checked whether an (for example, previously detected) object is already saved in a (for example, vehicle-internal) memory. If this condition B2 is not satisfied (N branch), the detected object is written to the memory in a next step S3, i.e., digitally saved. Further, the object receives a defined first identifier in the memory. By means of this defined first identifier, the information is saved that the object was actually detected in the last measurement cycle. In contrast to this, the information is saved by means of a defined second identifier that the object was detected in a previous measurement cycle, but was no longer detected in the last measurement cycle—and therefore its actual presence in the area surrounding the motor vehicle is only estimated.

If the condition B2 is satisfied (Y branch), i.e., if an object is already saved in the memory, a further condition B3 is checked whether the object detected in the current video image is identical to an object saved in the memory, to the extent that the saved object comprises the defined first identifier. If this is the case (Y branch), the object is kept in the memory and continues to retain the described first identifier. However, if this is not the case (N branch), i.e., if the detected object does not match a saved object having the first identifier (or if no object having a first identifier is saved in the memory), a condition B4 is checked whether the object detected in the current video image is identical to an object saved in the memory, to the extent that the saved object comprises the defined second identifier. If this is the case (Y branch), the object is kept in the memory and receives the defined first identifier again, because it has now been detected again. However, if this is not the case (N branch), i.e., if the detected object does not match a saved object having the second identifier, in a method step S7, the object saved in the memory is deleted to the extent that it bears the second identifier. That is, an object saved in the memory is not deleted if it bears the first identifier.

In a further method step S8, the newly detected object is saved in the memory together with the defined first identifier.

By means of condition B5, it is checked whether an object, which bears the defined first identifier, is already saved in the memory of the motor vehicle. If this is the case (Y branch), in a method step S4, the saved object is kept in the memory, but the identifier of the object is changed from the defined first identifier to a defined second identifier. In this way, the information is recorded that the previously detected object was no longer detected in the last measurement cycle. In a further method step S5, a definition of an environmental estimation area (so-called “predictor”) can be performed, in which a possible new detection in a next measurement cycle would be possible.

If, however, the condition B5 is not satisfied (N branch), a further condition B6 is checked whether an object is already saved in the memory of the motor vehicle, which bears the defined second identifier. If this is the case (Y branch), a counter is changed in a method step S6, which detects how often or how long the object once previously detected has not been detected any longer. Further, in this step, a further change of the environmental estimation area can be performed, in which a possible new detection in a next measurement cycle would be possible.

In a condition B7, it is checked whether a threshold value regarding the non-detected object is exceeded. In particular, whether a counter of allowed non-detection cycles has expired. If this is the case (Y branch), in a method step S7, the object saved in the memory with the second identifier is deleted.

In a condition B8, it is checked whether a termination criterion of the method is satisfied. If this is the case (Y branch), the method is ended in a method step S9.

What is claimed is:

1. A method for determining a signal state of a light signal system having several light signal emitters, wherein the light signal system has several signal states and a signal state is formed by one or more activated light signal emitters, the method comprising the following steps:
determining an object representing the signal state of the light signal system;
saving a determined first object having a first identifier when, in a first analysis cycle, it is detected that the first object represents the signal state of the light signal system;
changing an identifier of the saved first object from the first identifier to a second identifier when the first object is no longer detected in a subsequent analysis cycle;
deleting the saved first object having the second identifier, when a second object is determined in an analysis cycle, which represents a different signal state of the light signal system.

2. The method according to claim 1, further comprising:
deleting the first object having the second identifier when a characteristic of the second object satisfies a defined condition, wherein the defined condition is that the signal state of the light signal system represented by the second object is a defined subsequent signal state with respect to the signal state of the light signal system represented by the first object.

3. The method according to claim 1, further comprising:
deleting the first object having the second identifier when an age of the second object when an age of the second object is less than an age of the first object.

4. The method according to claim 1, further comprising:
deleting the first object having the second identifier when a determined size of the second object corresponds to a determined size of the first object within a defined tolerance threshold.

5. The method according to claim 1, further comprising:
defining a first environmental estimation area with respect to the first object having the second identifier, in which the first object is expected in a next analysis cycle.

6. The method according to claim 5, further comprising:
defining a second environmental estimation area with respect to the first object having the second identifier, in which the second object is expected in a next analysis cycle, wherein the second environmental estimation area in which the second object is expected is defined, considering a current signal state of the light signal system represented by the first object and depending on a specific signal state subsequent thereto, which is represented by the second object.

7. The method according to claim 1, further comprising:
deleting the first object having the second identifier when the second object is determined in a defined environmental estimation area with respect to the first object.

8. The method according to claim 1, further comprising the following step:
saving the second object having a first identifier when the first object having the second identifier is deleted.

9. The method according to claim 1, further comprising:
considering the saved object having the first identifier or the second identifier, in a further data evaluation.

10. The method according to claim 1, further comprising:
determining the object representing the signal state of the light signal system within a defined environmental estimation area when the first object having the second identifier is saved.

11. A device configured to determine a signal state of a light signal system having several light signal emitters, wherein the light signal system has several signal states and a signal state is formed by one or more activated light signal emitters, the device configured to:
determine an object representing the signal state of the light signal system;
save a determined first object having a first identifier when, in a first analysis cycle, it is detected that the first object represents the signal state of the light signal system;
change an identifier of the saved first object from the first identifier to a second identifier when the first object is no longer detected in a subsequent analysis cycle;
delete the saved first object having the second identifier, when a second object is determined in an analysis cycle, which represents a different signal state of the light signal system.

12. A non-transitory computer-readable medium on which is stored a computer program for determining a signal state of a light signal system having several light signal emitters, wherein the light signal system comprises several signal states and a signal state is formed by one or more activated light signal emitters, the computer program, when executed by a computer, causing the computer to perform the following steps:
determining an object representing the signal state of the light signal system;
saving a determined first object having a first identifier when, in a first analysis cycle, it is detected that the first object represents the signal state of the light signal system;
changing the identifier of the saved first object from the first identifier to a second identifier when the first object is no longer detected in a subsequent analysis cycle; and
deleting the saved first object having the second identifier, when a second object is determined in an analysis cycle, which represents a different signal state of the light signal system.
